(19) United States
(12) Patent Application Publication
(10) Pub. No.: US 2010/0097223 A1
(43) Pub. Date: Apr. 22, 2010

(54) PRODUCT SECURITY SYSTEM

(76) Inventors: James Robert Kruest, San Diego, CA (US); Paul Atkinson, Poway, CA (US); George M. Wohlhieter, Escondido, CA (US); Daniel Kline, Encinitas, CA (US); Thomas F. McGee, San Diego, CA (US); Jeff Shamblin, San Marcos, CA (US)

Correspondence Address: DLA PIPER US LLP, 1999 AVENUE OF THE STARS, SUITE 400, LOS ANGELES, CA, 90067-6023, US

(21) Appl. No.: 12/579,342

(22) Filed: Oct. 14, 2009

Related U.S. Application Data
(60) Provisional application No. 61/105,080, filed on Oct. 14, 2008.
(60) Provisional application No. 61/138,467, filed on Dec. 17, 2008.
(60) Provisional application No. 61/140,044, filed on Dec. 22, 2008.

(51) Int. Cl. G08B 13/14

(52) U.S. Cl. 340/572.1

(57) ABSTRACT

The present system provides a tag having one or more components comprising a physically rugged structure which can be attached to a product in a manner that renders the product inoperable, defaced, or that otherwise denies access to the intended use or value of the product until it is “unlocked” by means of a wireless communication, such as by a radio frequency transmission. The tag comprises a latching mechanism comprising in part an “actuator” and a “gripper”.

This patent application claims priority to each of U.S. Provisional Patent Applications 61/105,080 filed Oct. 14, 2008, 61/138,467 filed Dec. 17, 2008, and 61/140,044 filed Jan. 12, 2009 and each is incorporated by reference herein in its entirety.

### BACKGROUND OF THE SYSTEM

There are a number of techniques used to prevent or reduce theft from stores. One technique is to attach a physical device to a product that causes an alarm to sound if the product is removed from the store without first removing the device. There are a number of disadvantages of this system. One is the potential for damage to the product by the very nature of the attachment. Clothing often has a large bulky security tag attached to it that must be removed with a special tool. The attaching and/or removal of the tag can damage the fabric. Also, the tag may be unnoticed at checkout, or there may be more than one tag, so that the alarm is activated for a properly purchased product. At other times, the tag is faulty and the customer is at home with an un-removed tag, necessitating a return visit to the store.

### BRIEF SUMMARY OF THE SYSTEM

The present system provides a tag having one or more components comprising a physically rugged structure which can be attached to a product in a manner that renders the product inoperable, defaced, or that otherwise denies access to the intended use or value of the product until it is “unlocked” by means of a wireless communication, such as by a radio frequency transmission. The tag comprises a latching mechanism comprising in part an “actuator” and a “gripper”. The power necessary to operate the actuator is typically provided by the energy received from the radio frequency transmission via an antenna, or by a battery or cell (“battery”), either directly or via a power conditioning circuit such as a rectifier, filter and power regulator. The power may be gated or governed by a switch (“power switch”) which is controlled by a logic circuit in communication with an interrogator such as an RFID reader. The logic circuit may comprise discrete components or may be an integral part of an RFID chip or equivalent chip (“RFID chip”) suitably adapted to perform the function of controlling the power to an actuator. The RFID chip may also comprise the necessary provisions for secure authentication (e.g. a stored password and comparative logic) and subsequent associated actions such as operating the actuator (unlocking the tag). The antenna may be proximate in the physical structure.

### BRIEF DESCRIPTION OF THE DRAWINGS

FIG. 1 is a section view of an embodiment of the system.

FIG. 2 is a section view of an embodiment of the system for use with a CD or DVD.

FIG. 3 is a perspective view of the system of FIG. 2.

FIG. 4 is a section view of another embodiment of the system of FIG. 2.

FIG. 5 is an embodiment of the system of FIG. 4.

FIG. 6 is a top view of a ratchet and pawl type locking mechanism.

FIGS. 7A-7D illustrate a power coupling and switching system.

FIG. 8 is a block diagram of an embodiment with a supplemental battery.

FIG. 9 is an embodiment illustrating component configuration.

FIG. 10 is a section view of a basket locking embodiment of the system.

FIG. 11 is a section view showing the basket of FIG. 10 inside the latching mechanism.

FIG. 12 illustrates the hinged basket locking component of FIG. 10.

FIG. 13 illustrates a basket embodiment for clothing.

FIG. 14 illustrates a mechanism to retain grippers in an unlocked position.

FIG. 15 illustrates a gripper/housing alignment.

FIG. 16 illustrates a strain relief embodiment of the system.

FIG. 17 is an exploded view of an item device tag.

FIG. 18 is a detail of FIG. 17.

FIG. 19 is a rear perspective view of a DVD case.

FIG. 20 illustrates detail of a latch mechanism in a locked position.

FIG. 21 illustrates the latch mechanism in the unlocked position.

FIG. 22 is a sectional view of the locked latch of FIG. 21.

FIG. 23 is a sectional view of the unlocked latch of FIG. 21.

FIG. 24 is a sectional view of FIG. 23 with a post partly withdrawn.

FIG. 25 is an illustration of a hairpin embodiment of the system.

FIG. 26 is an implementation of a piano wire embodiment of the system.

FIG. 27 is a block diagram illustrating the key management of the system.

### DETAILED DESCRIPTION OF THE SYSTEM

The system is directed to a method and apparatus for providing product security that can be automatically disabled via wireless operation. The system provides a way to protect a product by rendering it inoperable, by denying access to the product or the ability to remove the product from packaging, by cosmetically affecting the product or by the presence of an non-removable object that interferes with the enjoyment of the product when the product is removed from a store without proper deactivation or removal of the device.

The system is a product tag that has several components, a first part (Part A) which can be placed in a locked engagement with a second part (Part B) to secure a product. In one embodiment, Part A is a male type connector (i.e. post) that is received by the female type receptacle Part B. Part B includes a gripper that secures the post of Part A and prevents disengagement. The gripper comprises a latch and a latch actuator. The latch is controlled by a latch actuator that can be set in an open or closed state via a signal, such as a wireless signal. The signal may be received by the actuator via an associated receiving circuit such as an RFID device. When signaled, the device can unlock the latch, removing or permitting removal of the product tag allowing use of the protected product. In some embodiments, this unlocking signal can be provided at the time of checkout at a retailing location, point-of-purchase, or at some other appropriate point. The device can be unlocked prior to use and a signal may be applied once the system is coupled to a product to activate the latch and retain Part A and Part B together.

In the following example, the system is described in an embodiment for protecting disc based products such as DVDs (and other optical discs such as Blu-ray discs, CDs, video games, software etc.). However, it should be understood that the system is not limited to this example and may be practiced in conjunction with other products without departing from the scope or spirit of the system. This example illustrates certain configurations of Part A and Part B, as well as some embodiments of latches that can be used with the system.

DVD Embodiment

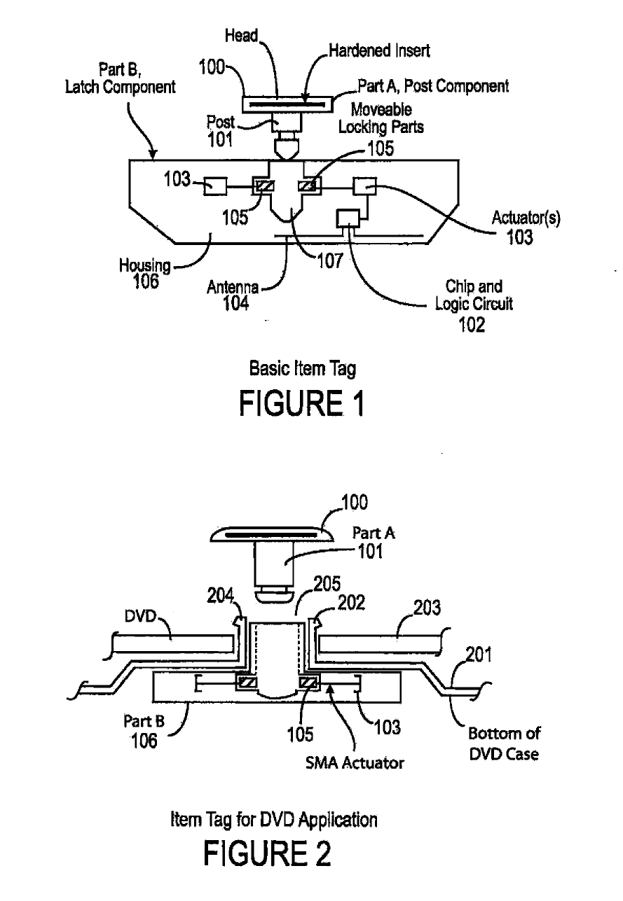

In the system for protecting a DVD, a product tag is provided that secures the disc to the packaging itself. The tag consists of two parts which are securely connected through the center hole of the DVD, and interfere with and/or prevent the disc from being played in a playback device or player. Referring to FIG. 1, the first part, Part A (“Part A”), comprises a nominally flat disc-like head 100 at least somewhat wider in diameter than the center hole of the DVD, and with a mast or post 101 (“post”) located near to the center of the head 100, but which may be offset from the center as required. The post 101 is constructed so as to have physical features which facilitate being gripped firmly by the second part, Part B (“Part B”). The head 100 may also provide a tab (not shown in FIG. 1) or equivalent means which can be grasped by the fingers to facilitate the removal of Part A after unlocking.

The tab is affixed to Part A only so firmly that it can aid in removing Part A when Part A is unlocked from Part B; otherwise if attempts are made to remove Part A prior to activation and unlocking, the tab will peel away from Part A or destruct, thus offering no assistance to an unauthorized attempt to remove Part A. The tab may be a flap portion of the material of the head of Part A, manufactured as part of Part A, or it may be a separate piece of material the same or different from Part A, and adhered to the head 100 of Part A with adhesive of the requisite adhesive properties or coupled to the head.

Part B comprises as appropriate the logic circuits 102, RFID chip, power conditioning circuit, antenna 104, battery or cell, power switch, the latching mechanism 105 and its actuator 103; and a housing 106 and having provision (i.e. formed opening 107) for receiving the post of Part A. The housing 106 of Part B, or equivalent means additional to Part B, also prevents the latching mechanism from being disadvantageously pulled or stressed by force being applied to Part A, particularly in an unauthorized attempt to separate Part A from Part B. By design Part B will be larger than the center hole of the DVD. In operation, the post 101 of Part A is positioned through the hole of the DVD and inserted into the receiving part 107 of Part B wherein it is held securely by the latching mechanism 105. The post 101 may also pass through the DVD case. So established, the DVD cannot be played in a playback device and is effectively valueless until the tag is removed.

The housing 106 is an integral part of Part B. The housing 106 together with the latching mechanism 103 holds securely Part A; the latch 103 grips the post 101 and the housing 106 holds the latch 103 in place. Together the housing 106 and latch 103 prevent Part A from being separated from Part B, and prevent someone from pulling on Part A, and in turn from pulling apart the latching mechanism and using the disc.

The flat disc or “head” 100 of Part A may be curved, dome shaped or otherwise configured to prevent it from being gripped in an unauthorized attempt to remove Part A from Part B or otherwise tampered with. The head 100 of Part A may comprise a “barrier” (e.g. a tamper resistant gasket) on the side proximate the disc to prevent a device being inserted between the head 100 and the disc in an unauthorized attempt to remove the tag (e.g. separate the two parts.) The barrier may also serve to keep Part A from scratching the disc.

The post 101 may vary in diameter up to nearly the diameter of the DVD's center hole. The post 101 provides a means that helps the gripper 105 of Part B securely grip the post 101 and lock Part A together with Part B. The post 101 may be solid and have grooves, indentations or protrusions etched, molded, machined or otherwise produced on its outer surface that facilitate its being gripped by the latching mechanism 105 in Part B. It may be hollow, open at the end or have one or more holes through it, and have grooves, indentation or protrusions etched, molded, machined or otherwise produced on its inside surface which can be gripped by a mechanism inserted into the interior space.

The post 101 of Part A may also be configured with a vertical slot so that it may facilitate insertion into the gripping components 105 of Part B by momentarily squeezing inward as the tip passes by the grippers 105, snapping outward again as the grippers engage the groove of the post 101. (See detail of post with the slot in FIG. 18.) Part A may be comprised of different materials. For example, the head 100 may be constructed out of hardened steel while the post 101 may be a plastic or composite material. The head 100 of Part A may contain a hard insert that is impervious to intrusion by drilling or cutting.

FIG. 2 illustrates the system in an alternate embodiment. In this configuration, Part B is configured into the back of the DVD case 201 (outside, bottom) and Part A is inserted through the center hole 204 of the DVD 203, through the rosette or spindle 202 that holds the DVD in place within the DVD case 201, and into Part B. In this configuration, the top 205 of the spindle 202 abuts the bottom of the head 100 and prevents direct contact between the head 100 and the surface of the DVD 203.

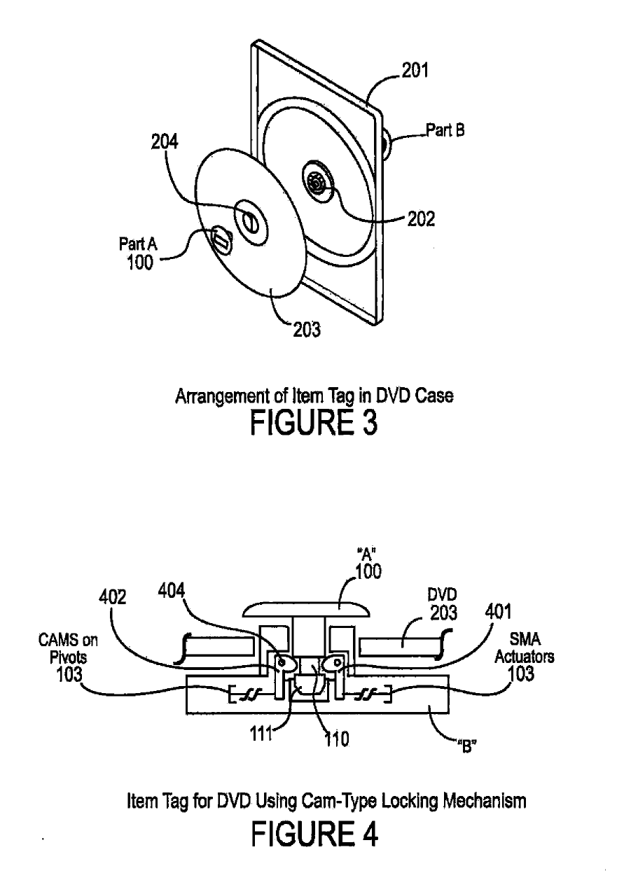

FIG. 3 is a perspective view of the embodiment of FIG. 2. The DVD case 201 includes a spindle 202 for receiving the DVD 203 via center opening 204. Part A is inserted through opening 204 and through spindle 202 to engage with Part B disposed on the back side of DVD case 201. The two parts engage to secure the DVD 203 in place, making it unplayable and un-removable.

In another embodiment, Part A and Part B secure the DVD 203 but are independent of the case. Part A is inserted through the center hole 204 of the DVD 203 and directly into Part B. In another configuration Part B is coupled to the inside, bottom of the DVD case (e.g. glued to or snapped into means for holding it.) In this configuration Part B may also have a post-like feature that acts as the spindle for centering and holding the DVD in the case. The DVD case itself may comprise a portion of the housing of Part B, so that for example the chip, circuit, antenna and latch components are contained all or partly in one portion of the housing, and the DVD case provides the remaining portion of the housing when assembled together. In another configuration, the head 100 of Part A may be designed to function as a support for the DVD 203 when packaged within a DVD case 201. Part A may be adhered with glue or other means to the DVD case, and its post may serve as a spindle, commonly referred to as the “rosette”, for holding the DVD in the case. In such a configuration Part A is considered to be on the underside of the DVD 203.

Part A and B may also be configured to accommodate having multiple DVDs in the case, by means such as lengthening the post 101 appropriate to the number of DVDs. Other variations are possible, such as having one or both of Part A and Part B on the outside of the DVD case 201, with openings in the case coinciding with the location of the DVD's center hole 204.

Part B Embodiments

FIGS. 4, 5, and 6 illustrate variations on the latches that can be used on Part B to receive and hold the post 101 of Part A. Referring to FIG. 4, there are shown two cam type latches 401 and 402 that pivot vertically with respect to the DVD 203. The latch 402 shows pivot point 404. The latch 402 pivots its head 406 toward and away from post 101 via action of actuator 103. The head 406 engages in a narrow portion 110 of post 101 to lock the mechanism in place.

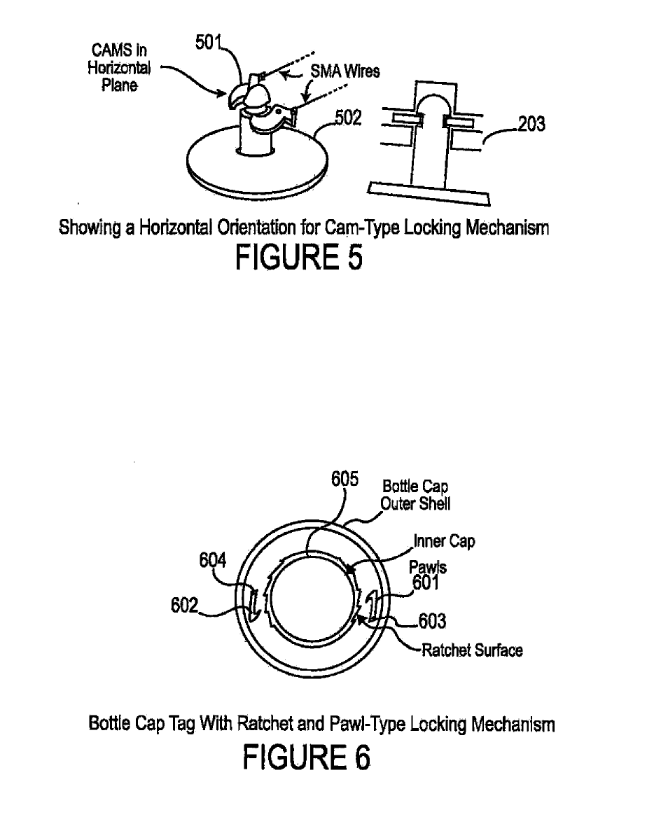

In a similar manner, FIG. 5 illustrates horizontally pivoting cams 501 and 502. These cams pivot in a plane parallel to a DVD 203 to engage post 101.

In some cases the tag may consist of only one part, with the corresponding other part being integral with the article itself or may employ means other than a post and a receiver. Such a tag may function as a plug, cap, or other like structure that locks onto a corresponding feature of the article being protected, denying access to its contents or other necessary part of the article, rendering it unusable or inoperable or otherwise diminishing its value.

The tag may be configured as a bottle cap, which spins freely unless it is unlocked (alternatively, the tag may be configured as a plug which locks onto an AC power connector port, common on a computer or instrument chassis). A locking bottle cap can use a circumferential “ratchet-like” surface which is grasped by pawls when the cap is unlocked. Prior to unlocking, the pawls are disengaged from the ratchet surface on an inner portion of the cap, and the shell of the bottle cap spins freely. When unlocked, the pawls grasp onto the ratchet surface so that turning the shell of the cap causes the inner threaded part to be screwed off the bottle.

FIG. 6 illustrates a “bottle-cap” type latch where pawls 601 and 602 engage a geared ring 605. The pawls pivot at points 603 and 604 respectively to engage toothed ring 605 and prevent disassembly of the mechanism. Only when the pawls are disengaged by activating actuators (not shown in FIG. 6) to pivot the pawls away from the ring 605 can the assembly be separated.

FIGS. 10, 11, 12, and 13 illustrate an embodiment of the system using a “basket” type of latch mechanism. One configuration of Part B uses a separate intermediate component, a thimble-shaped, “basket” 1001 into which the post 1002 is inserted. The basket 1001 is capable of being retained by the latching mechanism using the same means and techniques as described for the post 1002, and may be pre-locked into the latching mechanism during the initial assembly process. The design of this component is optimized along with the locking mechanism to provide maximum strength yet provide for easy unlocking when demanded.

The internal cavity 1003 of the basket is designed to work in conjunction with the post 1002 and allow for one-way insertion, and prevent extraction by means such as is common with a barbed fastener. When activated and unlocked, the basket 1001 is unlocked from Part B by retraction of the latches 105 via actuators 103, the post 1002 remains connected to the basket 1001 and both are simultaneously withdrawn from the latching mechanism.

Such an arrangement allows for a simple, controlled and lower cost insertion and latching of the post during the packaging (finishing) phase of a DVD production process. Additional anti-tampering is also afforded as the post 1002 may be designed to freely spin within the basket 1001, thus resisting attempts to shear off or otherwise break the post 1002 by twisting it. The attachment features of the post 1002 (e.g. indentations or protrusions such as barbs or ribs) may be machined as part of the post 1002 or may be separately formed (e.g. as a sleeve that fits over the post 1002) and adhered to the post 1002 by epoxy or other suitable adhesive.

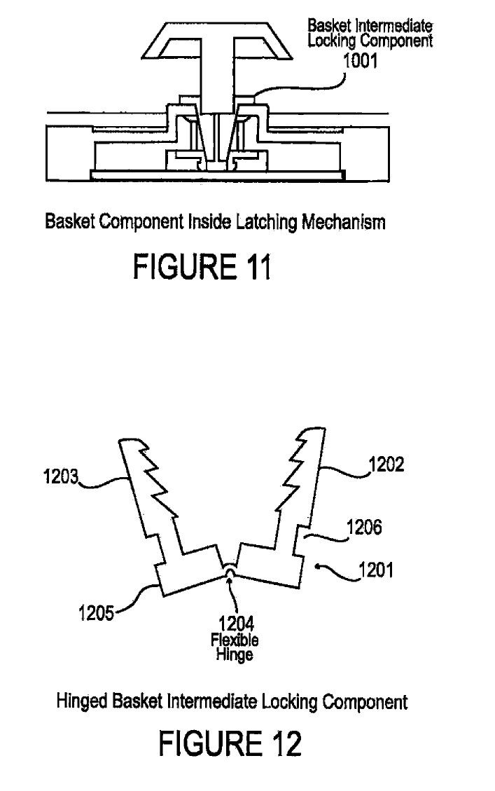

The sleeve may also be made of a temperature sensitive material that shrinks to fit around the post. To prevent it from being tampered/removed the material should expand (release the post) only at a temperature that would otherwise damage the tag or the product or packaging to which it was applied. The barbed features might also be formed by a dipping process, where the post 1002 is successively dipped into a suitable epoxy, cement, or suitable plastic to form ridges for gripping by the latch mechanism 105, or by the interior of the basket 1001. FIG. 11 illustrates the basket 1001 engaged with the latching mechanism.

A further embodiment is illustrated in FIG. 12 and provides manufacturing the basket 1201 with two or more pieces 1202, 1203 split vertically and hinged 1204 at the base 1205. The basket 1201 is designed with a shoulder or key 1106 that provides a physical stop to prevent the basket 1201 from fully disengaging from the housing of Part B. In this configuration, the basket 1201 is designed to allow unlocking and partial detachment from the latch mechanism 103, and to flare open when it is extracted by the post as it is withdrawn. The post 1002 is thereby released and the basket 1201 remains behind with the latching mechanism.

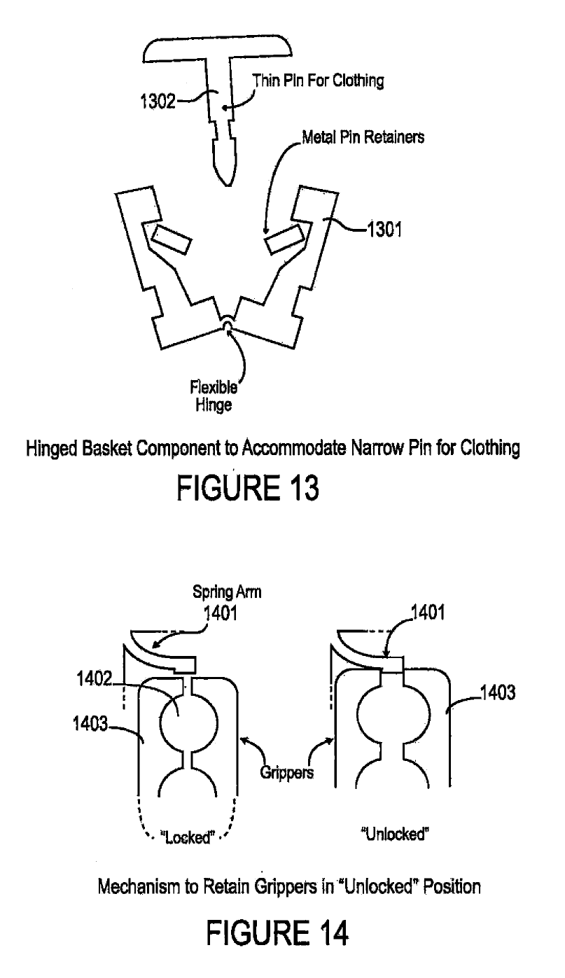

This configuration is advantageous for applications such as for clothing, as shown in FIG. 13, where the post 1302 must be very thin and needle-like to minimize damage to the clothing article during penetration and subsequent removal. The post 1302 can be easily removed from the article of clothing, while the basket 1301 component remains attached to the latch mechanism.

Locking Mechanisms

Locking mechanisms for tags comprise a mechanical latching component (latch) 105 and an actuator 103. The actuator 103 is activated for instance by an electrical voltage or current which induces movement which is used to change a mechanical state from locked to unlocked, or unlocked to locked. The actuator may be made of a shape metal alloy (SMA) having the property of changing its shape, for instance the shortening of a length of wire, when heated by an electric current. A suitable SMA is Nitinol, an alloy of nickel and tin; or Flexinol, a proprietary form of Nitinol manufactured by Dynalloy, Inc. of Costa Mesa, Calif. The SMA wire may be electrically connected using crimps or by adhering the wire to circuit traces using conductive adhesive. Other actuators are possible, such as electro-active polymers, thermo-active polymers, electro-constrictive or -expansive materials, piezoelectric materials, solenoids, and electro-magnetic rotary or linear motors.

The actuator uses a shape memory alloy known as nitinol made of a 50%/50% blend of nickel and titanium. SMAs are engineered to undergo a crystalline transformation from a low-temperature Martensitic phase to its high-temperature Austenitic phase over a small and controlled temperature range. Through the phase change an SMA will typically “shrink” by 4-5% and generate a usable force. The force generated during contraction provides the work to release the latch and free the post.

The SMA used in Aequitas' application is formed into a fine wire, 0.002″ in diameter, and is designed to go through its phase change in the range of 90° C., which is well beyond the normal shipping and storage temperature range for consumer oriented products. The SMA wire is connected mechanically to the latch mechanism, and electrically to a circuit that will turn power on and off to the actuator. It should be noted that other diameters can be used as appropriate for the application without departing from the scope and spirit of the system.

The actuator is mechanically coupled to the latch so that upon activation of the actuator the latch is unlocked or locked depending on the desired outcome. In certain cases the design of the latch advantageously uses mechanical advantage or leverage to increase force or movement in effecting the locking or unlocking process. The mechanical advantage may be implemented in a variety of forms including levers, cams, pulleys, screws etc. The latch components in particular are extremely strong and rigid parts that will not distort under the stress of attempts to separate Part A from Part B prior to unlocking. The latch components may be injection molded, and comprise living hinges to minimize assembly costs, reduce component counts and to provide integral spring functionality.

With a two-part tag suited for DVDs, clothing, razor blades, and similar applications, the latch 105 is designed to work with the post structure 101 of the Part A component of the tag. The post 101 has on its surface (inner or outer) indentations, grooves, holes or other irregularities that permit the latch 105 to firmly grasp the post in a locked position. The latch 105 comprises moveable parts that surround or penetrate features on the post 101 when the Part A and Part B are coupled together and that securely hold the two parts together until released. The moveable parts can comprise levers, cams, slides, pins, ratchets and other similar structures that mechanically grasp a suitable texture or topography of the post.

Ideally the mechanism is designed to withstand substantial forces which attempt to separate Part A and Part B. Further the design of the mechanism may be such that the separating forces cause the grasping mechanism to further tighten its hold on the post. The extreme resistance to removing Part A while in the locked condition is effected by the relative alignments of the gripping portion of the latch, the shape and depth of the surface features of the post, and the proximity and design of the housing and its stabilizing effect. In practice the action of pulling on Part A serves to wedge together the components that are holding Part A in place, so that primarily compressive forces are involved, rather than relying on resistance to flexing or bending of the structural elements, which can be much weaker. Further, the design and structure of the housing resist the twisting and tilting of the post which might otherwise compromise the ability of the latch to hold the post.

Typically, the latches themselves comprise a body that engages a groove or recessed area on the post, so that the latch engages a shoulder or other protrusion of the post to prevent axial movement. When the actuator is enabled, the latch is pulled away from the groove, slot, or recessed area, clearing the shoulder or protrusion, allowing axial movement of the post of Part A from Part B.

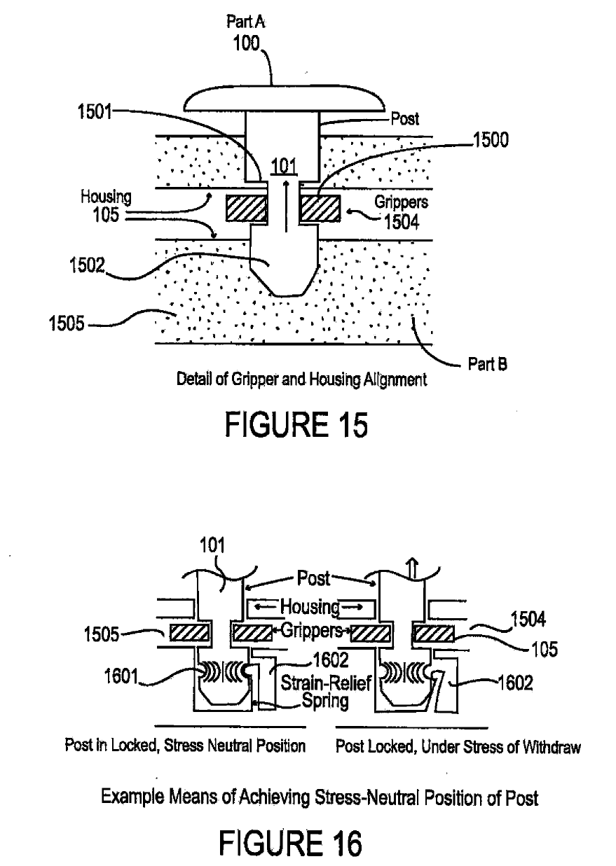

The operation of the latches 105 is shown in FIG. 15. The post 101 of Part A includes a groove or recessed area 1500 that defines upper 1501 and lower 1502 shoulders. The housing of Part B includes slots that act as guides and registers for the latches (grippers) 105. The latches in this embodiment move laterally back and forth in the slots 1504 and 1505. When the post 101 is inserted into the female opening of Part B, the recessed area 1500 of the post 101 is disposed approximately coincident with the slots 1504 and 1505. When the actuator is enabled, the latches are urged toward the recessed area and held in place, so that axial movement of the post is prevented.

Stress Relief

When the post of Part A is inserted into Part B there is often an undesirable amount of pressure between the two parts, arising from the DVD and the case pushing them apart, even when they are “at rest” with no intentional forces exerted. It is desirable to minimize this “at rest” pressure in order to facilitate the actuator's ability to reliably release the latch and its hold on Part A when unlocked. The design of the housing in conjunction with the post provides for a “strain relief”, typically consisting of a rounded, flexible “button” that rests against a corresponding “indentation” on the post, so that the button and indentation engage each other when the post is inserted into Part B. This stress relief system provides enough resistance to retain the post in a desired position where the registration of the area of the post that is to be gripped coincides with the location of the grippers.

FIG. 16A and FIG. 16B illustrate the operation of the stress relief system. A button 1602 is spring biased toward the post 101 in the female portion of Part B. The post 101 includes a recessed region 1601 that is such that the button 1602 is displaced as the sloped tip of the post 101 is inserted into the opening and then the button 1602 clicks into place as the region 1601 is coincident with the button 1602. The button 1602 and indentation 1601 are positioned so that when engaged their pressure holds the post 101 in a stress-neutral position relative to the latch. This resistance can be overcome with relatively low force, but in the absence of such force, the post stays in the neutral position. The latch's movable gripping surfaces 105 therefore exhibit little resistance to moving into the locked and/or unlocked position when the actuator is activated.

AS can be seen in FIG. 16B, when an upward force is applied to the post 101 sufficient to overcome the spring effect of button 1602, the latches 150 are compressed against the shoulder of the body of Part B, preventing further movement. In this state, there is greater force required to move the latches 105 to an unlocked position due to the friction and orthogonal force being exerted on the latches. Release of the upward force results in the post returning to a neutral position. While a button and indentation serve to illustrate how the strain relief may be implemented it should be noted that other means may also achieve the equivalent result.

FIG. 14 also illustrates a system of keeping the grippers unlocked after activation of the system, facilitating the removal of Part A and Part B as desired. A spring biased arm 1401 is urged against an opening 1402 in the grippers 1403. When the grippers are opened by activation of the system, the spring urges a tab into the opening 1402, blocking the reclosing of the grippers.

Reuse of Tags

Tags may provide for both unlocking and subsequent relocking and contain two or more actuators acting in opposition, each activated independently from multiple connections to the chip and logic circuit in response to separate operational commands. Alternatively, the latch mechanism may provide a mechanical means for manually relocking Part A and Part B together, effected by a button or lever that can be pressed or moved by hand. Another means causes the latch mechanism to be reset when the post is re-inserted into Part B and the latch.

The locking mechanism may require a twist to lock after inserting the post. The moveable locking parts then prevent the Part A from rotating to the unlocked position. The locking mechanism may take the form of a bevel or screw, or be a flat shoulder. When the moveable locking parts are moved by the actuator the post is then free to rotate in the reverse direction where it is no longer locked in place and can be removed.

Tag Configurations

As a deterrent to tampering, one or both Part A and Part B may contain an indelible ink having a strong propensity for staining the product, an adhesive having a strong propensity for rapidly adhering to the product, or an unpleasant odorous gas, that is released if an unauthorized attempt is made to remove the tag prior to an unauthorized transaction, thus imbuing the article with an unsightly stain, physical irregularity, or peculiar smell, which renders the protected article unusable or undesirable. Placing the inks and adhesives under pressure and inside a brittle vial assists in the dispersion of these materials when a tampering event causes the vial to break, assuring that the ink or adhesives are effective in making the product essentially unusable.

In construction, the tag components and housing are made of hard materials that resist cutting, puncturing and tearing. The housing also provides structural integrity for the tag, simultaneously maintaining the post of Part A in a fixed position relative to the latching mechanism, and securely retaining the latching mechanism in position in the tag body. Many plastic materials today are suitable. Further tamper resistance may be achieved by adding hardened metal, such as 304 Stainless Steel or Tungsten or Silicon Carbide; composites (e.g. graphite or polyester compounds); or ceramic shielding that prevent drilling or puncturing in potentially vulnerable areas. The electrical components may be assembled on a separate substrate, such as fiberglass printed circuit board material, PET or polycarbonate. The substrate may also be made of hard materials, (e.g. graphite or polyester composites or ceramics) that are themselves tamper resistant, suitable for mounting the electronic components and latching mechanism, and that do not interfere with RF communications. The tag housing substrate may also serve as the circuit board substrate directly, eliminating the cost of separate materials. Conducting lines and antennas may be deposited and etched into the appropriate patterns, or may be directly printed using a variety of conductive inks. The components of the RFID chip and logic may be assembled using standard electronic assembly techniques.

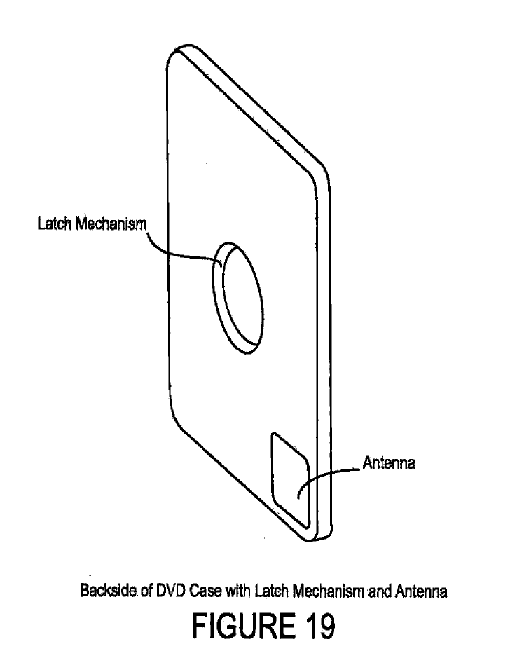

It is frequently desirable that the antenna component be located remotely from the chip and latching mechanism. For example, in a DVD application the latching mechanism is located centrally to the disc and its case, however it may be advantageous to locate the antenna toward a corner of the case, or along its spine. It may also be advantageous to configure the antenna directly into the case itself, by metal deposition and etching, or by printing, or by other appropriate means, such as shown in FIG. 19. Electrically conductive patterns, traces, are fashioned to convey the RF energy from the remotely located antenna to the chip, interface circuit and latch mechanism. The antenna may alternatively be constructed on a separate flex substrate, such as Mylar or polyimide, along with an extension of the substrate with conductive traces to connect to the chip, interface circuit and latch mechanism. Conductive adhesives may be used to make electrical connections between the antenna flex circuit and the chip substrate. Various sizes and shapes of these substrates and antennas can be configured to accommodate numerous case styles and operational requirements.

A tag for AC power receptacles may use pins, levers, cams and other similar structures to engage and grasp a part of the product. For instance the universal AC connector used on electronic instruments and computers consists of a male connector recessed into the chassis. A tag configured as a plug uses a moveable part to grasp a notch or hole on the electrodes, or a ridge, groove or hole on the inside of the recess of the chassis. The tag plug, when locked onto the products power connector, prevents connecting the AC power cord and the unit cannot be powered up.

In operation the actuator exerts a force on a movable part of the latch mechanism. If the latch is in a first locked state, the movement of a cam, pin, slide, lever or other structure effected by the actuator causes the latch to become unlocked and Part A and Part B are capable of being separated. Part A and Part B may become unlocked, yet remain in their respective positions until they are manually separated. Alternatively Part A and Part B may at the time of unlocking be separated by a spring or other flexible member causing the parts to separate. The latch mechanism may also provide for retaining the moveable locking part of the latch in an unlocked state, so as to prevent inadvertent relocking of Part A and Part B. This may be advantageous when the tag is located inside of other product packaging and is not accessible at retail checkout.

Living Hinge With Locking Brace

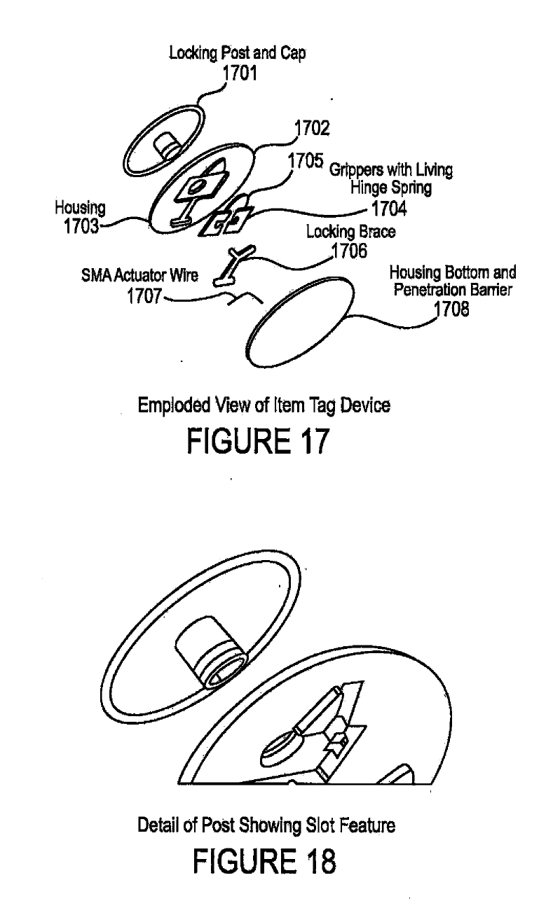

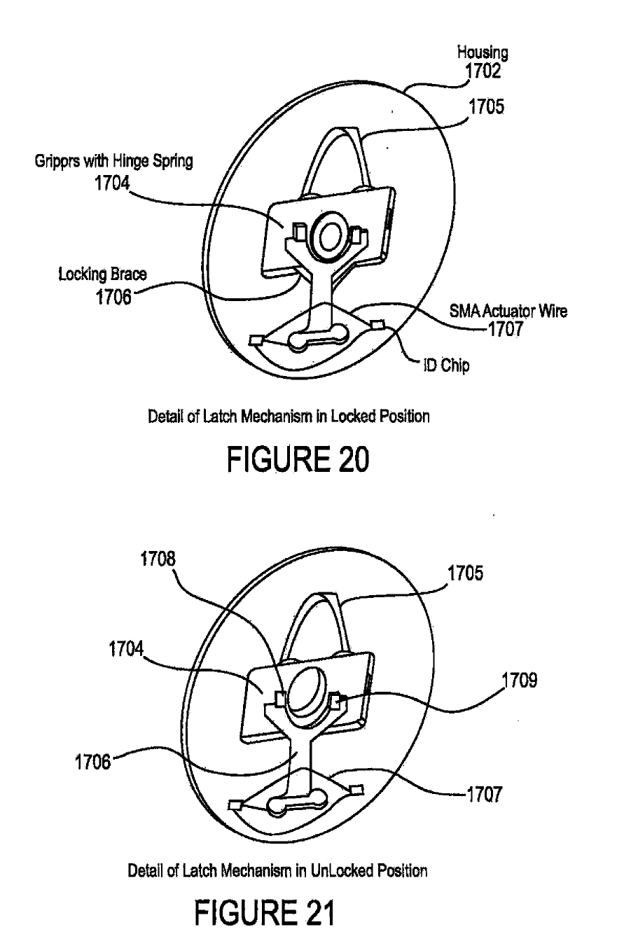

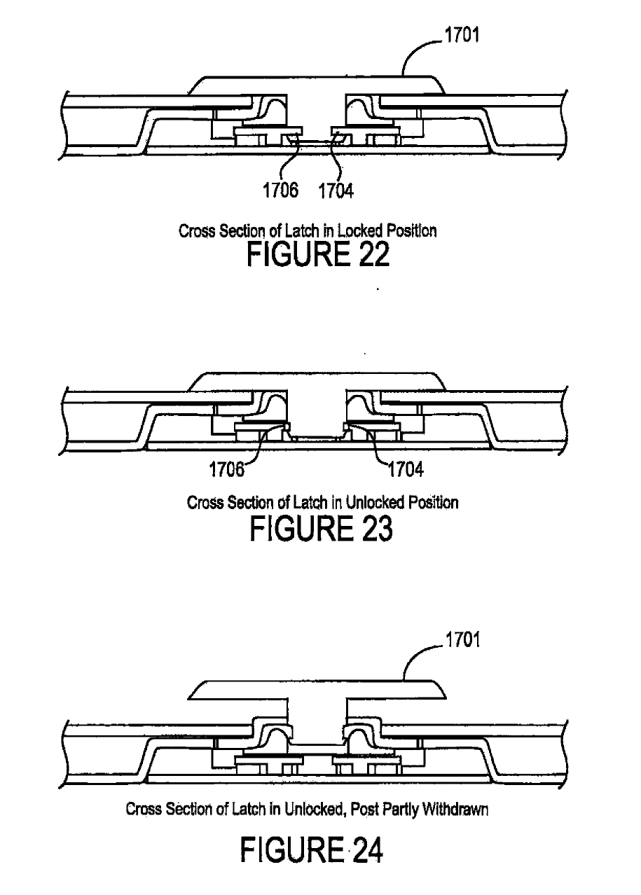

In one embodiment of the system, a custom DVD package is implemented that includes a gripper mechanism having a living hinge spring that is opened and closed via a locking brace that is displaced by SMA wire. This embodiment is illustrated in FIGS. 17-24 and described here. FIG. 17 is an exploded view of the components of this embodiment. A special housing 1702 has a recessed pattern 1703 formed therein for receiving parts of the system.

A gripper 1704 comprises split C or D shaped portions having a living hinge 1705 connecting the halves. A locking brace 1706 is coupled to the grippers and is used to move the grippers back and forth in a recessed opening in the back of the housing 1702. The gripper halves surround an opening in the housing 1702 for receiving the post. The living hinge spring is disposed in a V shaped slot that permits some movement of the spring so that when urged upward, the spring causes compression of the gripper halves, moving them toward the opening to lock the post in place.

The locking brace 1706 is a Y shaped member whose upper arms engage tabs 1708 and 1709 on either gripper half 1704 to cause upward movement of the gripper, activating the spring 1705, and closing the gripper halves. When the locking brace 1706 is lowered, the spring urges the gripper halves downward and outward, releasing the post and allowing separation of the pieces.

The locking brace 1706 is moved by action of SMA wire 1707. In one embodiment the wire is in an inverted V shape and electrical activation causes the SMA wire 1707 to exert force on the locking brace to urge it in one direction or another, consequently opening and closing the gripper 1704 halves.

Hairpin Embodiment

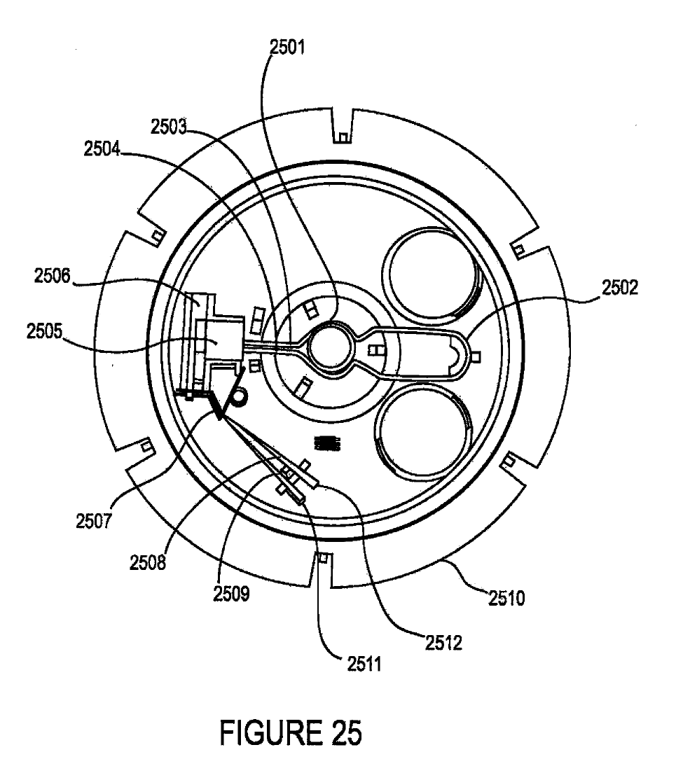

FIG. 25 is an embodiment of the system using a hairpin type restraint to lock the pin in place. The post 2501 is held in place in the hub via the curved hairpin spring 2502. Spring 2502 is a metal spring that is shaped so that its stable state is open, releasing the post 2501. In FIG. 25, it is shown in the locked position. The ends 2503 and 2504 of the spring 2502 are squeezed together and inserted into member 2505. The spring 2503 supplies a force on member 2505 that urges it to the left but is prevented from moving by slide 2506. Slide 2506 is coupled to spring 2507 which is biased to allow slide 2506 to move down, allowing member 2505 to move left, releasing spring ends 2503 and 2504 to open and thus releasing post 2501.

The spring 2507 is prevented from moving by SMA members 2508 and 2509. When a signal from chip 2510 is applied to the actuators 2511 and 2512, the SMA members 2508 and 2509 retract, allowing spring 2507 to move slide 2506 downward, permitting the opening in slide 2506 to be coincident with member 2505, allowing it to move to the left and release spring 2502.

Piano Wire Embodiment with Optional Temperature Protection

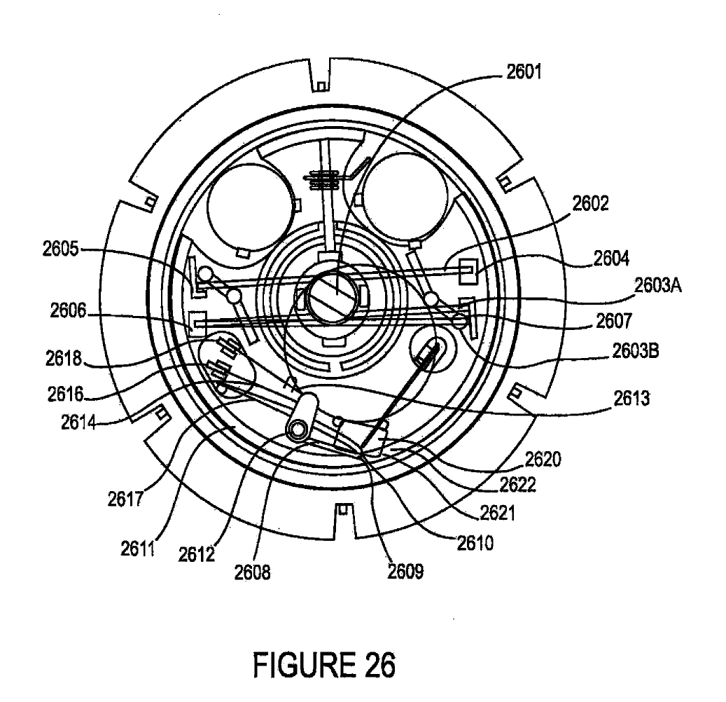

The embodiment of FIG. 26 is referred to herein as a piano wire embodiment but the system may or may not use piano wire or some other spring material to effectuate retention of the post during the locking phase. The post 2601 includes a slot or groove that is engaged by spring wires 2602 and 2603 above and below the post 2601. Spring wire 2603 is illustrated in both an engaged position A (upper) and unlocked position B (lower) to better illustrate the operation of the system. In one embodiment, the end of the post has an elevated “mesa” having a dimension smaller than the diameter of the post, which facilitates the insertion and locking of the post into the piano wire gripper structure. The mesa portion allows a partial insertion, and a subsequent twisting and pushing action on the Part A causes the piano wire to spread enough to allow complete insertion and locking of the piano wire into the groove of the post.

In this embodiment, the right side of spring wire 2602 is fixedly mounted in slot 2604. The left side of spring wire 2602 is movably mounted in slot 2605. Conversely, the left side of spring wire 2603 is fixedly mounted in slot 2606 and the right side of spring wire 2603 is movably mounted in slot 2607. The system is mounted on a rotatable plate whose clockwise rotation will release the springs from the post and allow the system to unlock.

The rotation of the plate is prevented by the pawl 2608 whose end 2609 engages a notch 2610 in the edge of plate 2611. The pawl 2608 is pivotally mounted on post 2612 and includes a pivot arm 2612 that is coupled to SMA wires 2613 and 2614 coupled to actuators 2615 and 2616 respectively. The pawl 2608 includes spring arm 2617 that keeps a slight bias on the pawl to keep it engaged in the notch 2610. However, the action of the SMA wires can overcome that bias and pivot the pawl 2608 so that it disengages from the notch 2610. The natural bias of the spring wires 2602 and 2603 causes clockwise rotation of the plate, releasing the springs due to the oppositely disposed movably mounted ends.

The system of FIG. 26 includes a temperature protection mechanism to prevent unauthorized disabling of the system by the use of heat. A thermal protection member 2620 includes an corner 2621 engaging notch 2622 in the rim of the plate. The activation temperature of this mechanism is much lower than the activation temperature of the pawl mechanism and associated SMA. At a temperature well below the activation temperature of SMA wires 2613 and 2614, the protection member 2620 locks into place by engaging slot 2622 (As shown in FIG. 26) to prevent movement of the rotating plate and retaining the spring wires 2602 and 2603 in place. The temperature protection device may be a bi-metallic strip that is tailored to move into a blocking position at a temperature lower than required for the wire to actuate. Other materials may also be suitable, such as thermo-expansive polymers, or shape memory alloys.

One of the advantages of the system is that it can be manufactured on a plate as shown above and added to existing packaging, such as DVD packaging. In other instances, the system is built into the packaging itself.

Circuitry

The power necessary to operate the actuator comes in one embodiment from a small 1.5V button cell battery located securely within the body of the lock. When switched on, the battery delivers electrical current to the SMA actuator, causing it to heat up, reaching its transition temperature within 0.5 second. In doing so, the SMA contracts and pulls the release trigger on the latch. At that point, internal spring forces complete the unlocking sequence and free the post from the lock's grip. Once released, the design of the latch assures that the lock remains open and does not inadvertently re-lock itself.

Within the lock, the events are controlled by a customized version of a radio frequency identification (RFID) chip. RFID can be viewed as an “advanced bar code” that is scanned by a specialized radio rather than a laser scanner, and can be programmed with additional information about a product to which it's attached.

The chip is customized with an input/output (I/O) interface that connects to the locking actuator. The output of the RFID chip is an open drain of a field-effect transistor (FET) specially sized to switch on and off the actuator current from the button cell battery. When the lock is in the normal “locked” state, the FET is “off” and no current flows through the SMA actuator. During a POS transaction, the unique ID of the chip is read by the POS RFID reader, and a corresponding digital key is sent to the chip. Internally, the chip validates the key as being correct, and causes the FET to turn “on”. This in turn allows the current to flow from the battery to the SMA wire and open the lock.

In one embodiment, the actuator receives its operating power from the energy in the RF field supplied by the RFID reader or from an other RF field source provided. The tag contains at least one antenna tuned to the operating frequency of the RF source which is capable of receiving the RF signal, consisting of a communication data stream with the chip or logic circuit in the tag, and capable of harvesting the energy for conversion into useful power to operate the actuator. Separate antennas may also be used, where the first antenna is useful for communication with the chip or logic circuit, for instance using the ISO 14443A protocol at 13.56 MHz or the EPC Gen2 protocol at 915 MHz, and the second antenna is useful for harvesting the RF energy at the same or a different frequency from the communication. In the case of the latter, the communication with the chip or logic circuit controls a switch in the logic circuit which turns on or off the power to the actuator. The switch may be a field effect transistor (FET), a bipolar transistor, or other type of switch suitable for the application.

In some applications the power in the RF field may not be sufficient to operate an otherwise desirable actuator, or from an advantageous distance. In this case the power may be supplemented or provided in its entirety by a separate battery or cell (e.g. a watch, button or coin cell, or thin-film battery.)

The latching mechanism further provides for indication that the required motion of the actuator to unlock the tag has occurred. A sensing switch integral to the latch mechanism senses when the locking pin, lever, cam or other locking part has moved sufficiently to unlock the tag and provides a signal to the chip or logic circuit. The signal indicates that the switch contacts have closed, confirming that the latch has unlocked. Correspondingly the chip or logic circuit is electrically connected to the sensing switch, and can sense the condition of the switch by monitoring the relationship between current and voltage across the switch. The confirmation status can then be queried by the reader and the unlocked status confirmed to the point of sale system (POS).

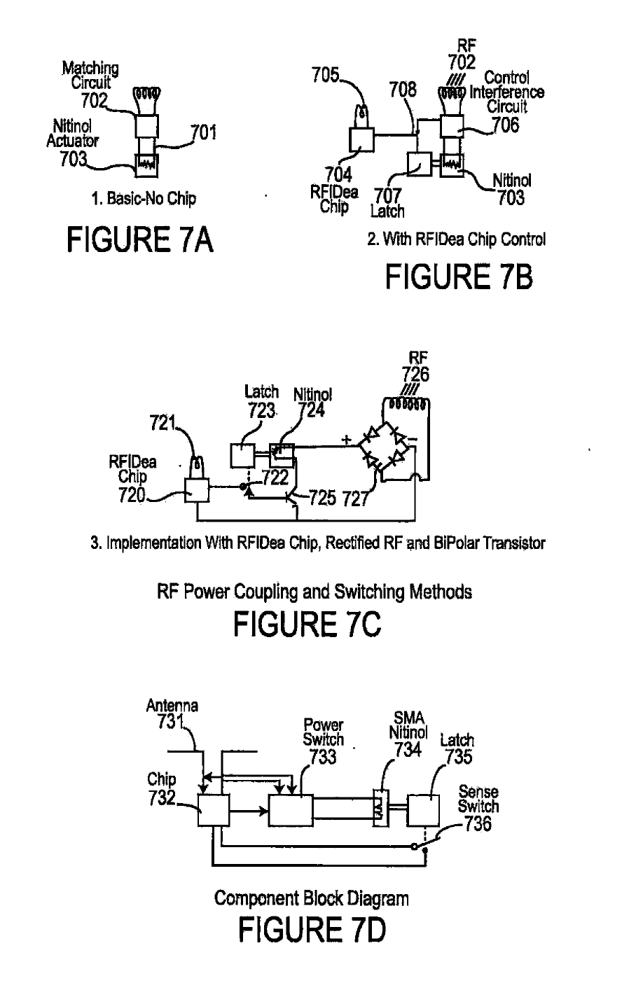

FIGS. 7A-7D illustrate a number of circuit configurations in the system. Referring first to FIG. 7A, a “no-chip” embodiment is illustrated. A matching circuit 701 includes an RF antenna 702 for receiving a signal from a POS transmitter. The SMA activator 703 is energized when circuit 701 receives the proper signal, actuating the SMA and thus unlocking the device.

FIG. 7B shows an embodiment with an RFID chip 704 with an associated antenna 705. The control interface circuit 706 has its own associated RF antenna 702 to harvest energy and to receive signals. The RFID circuit 704 controls a switch 708 coupled to control circuit 706 and latch 707. When triggered, the switch and latch allow the SMA actuator 703 to energize the SMA and unlock the system.

FIG. 7C shows an embodiment with an RFID chip 720 and associated antenna 721, latch 723, actuator 724, rectifier 727, RF antenna 726, switch 722 and transistor 725 and operates as described above. FIG. 7D illustrates the system at the component level. An antenna 731 receives a signal and/or power which is provided to a control chip 732. The chip controls a power/switch component 733 which in turn controls SMA actuator 734. A sense switch 736 is coupled to latch 735 that indicates to the control chip that the latch is activated, which condition can be transmitted back to a POS station to indicate successful unlocking of the system.

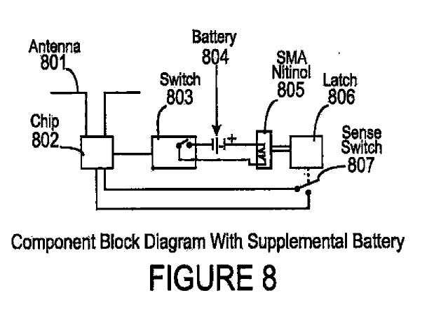

FIG. 8 is another component implementation of the system with a battery. Antenna 801 is coupled to control chip 802. Control chip 802 is coupled via switch 803 to SMA actuator 805 and both are coupled to battery 804. SMA actuator 806 is coupled to latch 806. Sense switch 807 can detect when latch 806 is activated so that control chip 802 can transmit a signal to a POS station.

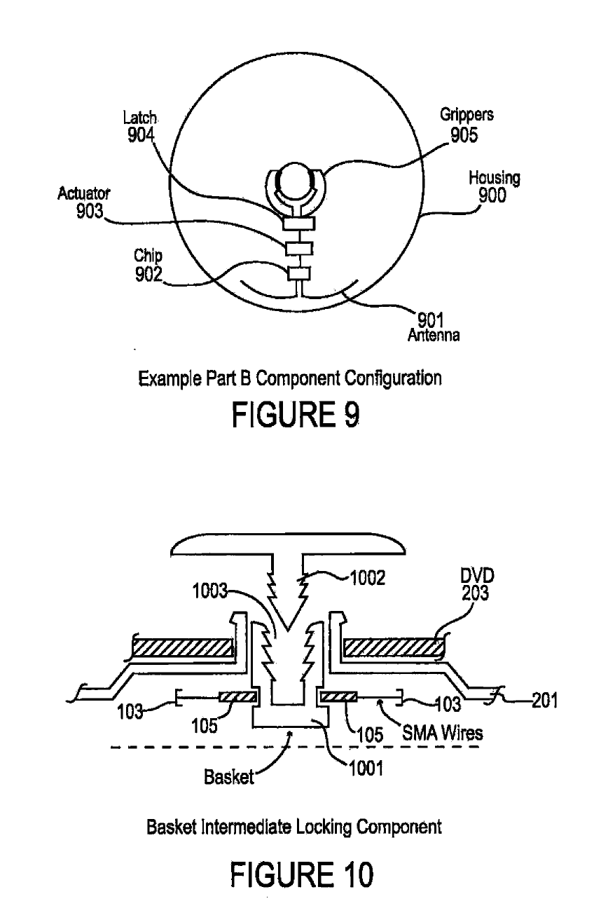

FIG. 9 illustrates another embodiment of a component system where the entire system is built into a housing 900. Antenna 901 is built on the surface of, or made integral with, housing 900. Mounted on the surface of housing 900 are control chip 902, actuator 903, and latch 904, which control the locking and unlocking of grippers 905.

Key Management

A weakness that is shared across all existing retail security systems is the use of a standard “key” or unlocking device which is common to a broad class of “tags”. Even when new tag types are introduced, the fundamental architecture is still a “master keying” system whereby a common key is used to unlock many, many locks—essentially a 1:N relationship. Once a thief has the master key, he or she can disarm an entire store's inventory. The system's solution takes a fundamentally different approach, whereby each wireless lock has a unique digital key that is associated with only 1 item (a 1:1 key), and it is only provided at the time of retail sale. By “locking” (disabling) products at the point of manufacture (with either electronic or electro-mechanical locks depending upon the product type) and enabling the “un-locking” process to only occur at the retail point-of-sale (POS), the system provides for improved security.

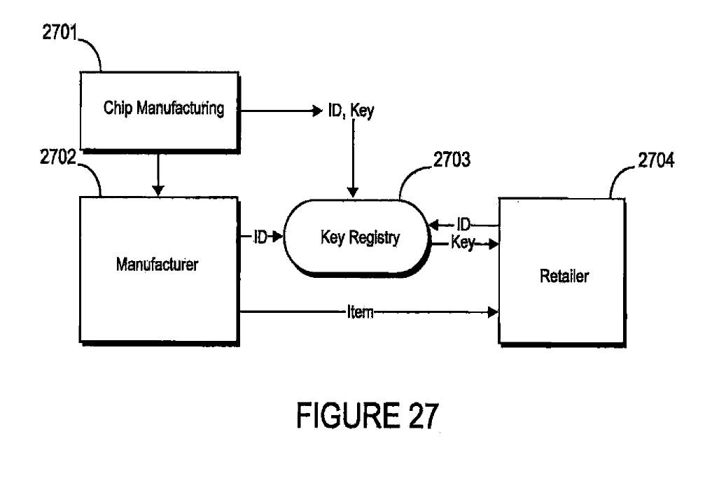

FIG. 27 is a block diagram illustrating the key management of the system. At the chip foundry 2701 the chips are ‘personalized’ with a unique public ID and a unique password or digital “Key”. Both are written to non-volatile memory in the chip. The ID is accessible to everyone. The chip's Key is not externally accessible and is used by the chip to compare a key received from a reader and when they match, unlock the lock.

The ID and Key pair are securely transmitted to the Key Registry 2703 which acts as a trustee on behalf of the manufacturer 2702 and retailer 2704 and keeps the keys separate from the physical product until retail checkout. The Key Registry 2703 always maintains the ID/Key pair for every system lock. This ensures the interoperability of every part of the system: the Key Registry 2703, the POS readers and all wireless locks whether they are made by the system or a third party.

At the product manufacturer 2702 products are secured with system locks, which are applied at the end of the manufacturing process. The specific product determines which lock is appropriate and it is attached in a manner so as to not alter the design, utility or warranty obligations of the underlying product.

At checkout, the cashier scans or “reads” the product similarly to how they scan bar codes or deactivate EAS tags today. The reader wirelessly reads the lock's ID and transmits it to the Key Registry (or local Key Server). The Key Registry 2703 authenticates the reader (validates the request), associates the ID with the appropriate Key and returns the Key to the POS reader. The reader relays the Key to the product, where the chip compares the transmitted Key to its stored key and if they match, the lock is unlocked.

In one embodiment, a “Key Server” can be used which locally stores Keys for products in that retailer's inventory. The Key Server is a computer system with a hardware encryption element running specialized software that provides a gateway to the Key Registry and distributes Keys to the store's POS RFID readers when requested. All information contained in the Key Server is encrypted such that a theft or loss of a Key Server does not undermine the overall system's integrity. The Key Server also transmits completed unlocking transaction information back to the Key Registry. This allows the Key Registry to maintain transactional history about each product's lock (no customer data) and in the future provide valuable information services to manufacturers and retailers.

As manufacturers and suppliers supply the Key Registry with the IDs and destination/retailer codes for products it has shipped, the Key Registry will automatically transmit the ID and associated Key to the Key Server(s) at the retailer's distribution center(s) or stores. By doing so, the ID/Key pairs are “pre-cached” at the store when the products arrive. Alternatively, or together with the caching model, the retailer can read the IDs from products as they arrive (or at any time the product is in the store) and request the keys from the Key Registry. The Key Registry will then send the ID/Key pair to the specific Key Server which initiated the request.

For implementations that use local Key Servers, the default ID/Key look up will be to the local, in-store (or retailer's network) Key Server. If for some reason a product's Key is not found on the local Key Server, the ID will be passed to the Key Registry and the Key will be returned to the store. As noted previously, the Key Registry is the ultimate repository for all Keys and is always available as a primary or backup source of the Keys—to authorized/certified retailers (locations/readers).

Other Product Implementations

In another embodiment of the tag, the post is considerably smaller in diameter, sharpened to a point, and capable of piercing an article of clothing without causing damage to the article. When attached to a garment in a conspicuous place it makes the garment undesirable to wear and valueless to a would-be thief. This embodiment, unlike conventional electronic article surveillance or EAS clothing tags, provides for wireless, and especially, RF, unlocking and item-level security via the RFID chip.

In another embodiment the tag is used to secure multiple items such as replaceable razor blade cartridges, such as those sold by Schick or Gillette. To accommodate numerous cartridges within a single package the post is configured to be an elongated pin-like structure, composed of a tamper-resistant material, e.g. hardened steel, that passes through openings in each cartridge. Parts A and B are then locked together so that the individual cartridges are not usable. Part A and Part B may be independent of the package and disposable. Alternatively, Part B may be a permanent part of the package or a dispenser that holds the items until they are consumed one at a time.

What is claimed is:

1. An apparatus comprising:
a first part;
a second part removably coupled to the first part;
a latch for securing the first part to the second part and to a product;
a controller for disabling the latch to permit separation of the first part and the second part.

2. The apparatus of claim 1 wherein the controller comprises an RFID chip.

3. The apparatus of claim 2 wherein the latch is coupled to the controller via at least one SMA wire.

4. The apparatus of claim 3 wherein the latch is coupled to the SMA wire via a spring.

5. The apparatus of claim 4 wherein the spring unlocks the latch when the SMA wire is activated.

6. The apparatus of claim 5 wherein the RFID enables the actuator when an appropriate signal is received.

7. An apparatus comprising:
a housing having a latch and a controller coupled to the latch, the housing having a receptacle for receiving a locking member.

8. The apparatus of claim 7 further including a package receiving the housing for securing a product to be placed in the package.

9. The apparatus of claim 8 wherein the controller comprises an RFID chip.

10. The apparatus of claim 9 wherein the latch is coupled to the RFID chip via at least one SMA wire.

11. The apparatus of claim 10 wherein the package is a DVD package.
